(19) United States
(12) Patent Application Publication
(10) Pub. No.: US 2007/0280164 A1
(43) Pub. Date: Dec. 6, 2007

(54) Base Station and Mobile Communication Method

(75) Inventors: Toshiteru Hayashi, Kanagawa (JP); Hiroaki Asano, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/575,542

(22) PCT Filed: Aug. 29, 2005
(86) PCT No.: PCT/JP05/15676

§ 371 Date: Mar. 19, 2007

(30) Foreign Application Priority Data
Sep. 21, 2004 (JP) 2004-274137

(51) Int. Cl. H04Q 7/00

(52) U.S. Cl. 370/331

(57) ABSTRACT

A base station capable of maintaining a signal quality and appropriately controlling a transmission power, taking into account the radio propagation characteristics of some different frequency bands, thereby drawing the best out of the system performance. In this base station (120), a mobile speed determining circuit (125) determines the mobile speed of a mobile station (110). A band determining part (126) determines whether the mobile speed of the mobile station (110) is greater or smaller than a predetermined threshold. A band control circuit (127) controls a wireless receiving circuit (123) and a wireless transmitting circuit (130) such that they use a low frequency band when the mobile speed is greater than the predetermined threshold and that, otherwise, they use a high frequency band.

### TECHNICAL FIELD

The present invention relates to a base station and mobile communication method in a mobile communication system including a plurality of mobile stations using some different frequency bands and the base station that performs wireless communication with the plurality of mobile stations.

### BACKGROUND ART

In the mobile communication system, due to a increase of the traffic amount and the like, methods for improving frequency use are desired. Among the methods, measures are taken to allocate a new frequency band different from the existing frequency band and operate the same system (service) in these different frequency bands.

Embodiments of Personal Digital Cellular (PDC) system on 2nd-generation telecommunication system will be described.

The PDC system began in 1993 in a band of 800 MHz, and introduction of a band scheme of 800 MHz which shares a band of 1.5 GHz (sharing band scheme) started in 2001. A mobile station (MS) supporting the scheme has functions of waiting and communicating in bands of 800 MHz and 1.5 GHz (Non-patent Document 1).

In an area supporting the scheme, it is possible to shift a channel to the band of 800 MHz or 1.5 GHz according to information from a radio network control (RNC) apparatus which is an upper station, and disperse the traffic of the band of 800 MHz to the band of 1.5 GHz.

A control method of this scheme will be described below. During standby, as shown in FIG. 1, information indicating a current area is reported by broadcast information to identify whether the area is a supporting area where the bands of 800 MHz and 1.5 GHz overlap or a non-supporting area of only the band of 800 MHz. In the supporting area, mobile station 11 is on standby in one of the bands of 800 MHz and 1.5 GHz, and monitors peripheral zones (bands of 800 MHz and 1.5 GHz) reported by the broadcast information.

Meanwhile, in the non-supporting area, mobile station 11 is on standby in the band of 800 MHz. When mobile station 11 enters the supporting area from the non-supporting area, band allocation processing is performed to determine a standby frequency band in the supporting area.

The band allocation processing will be described below with reference to FIG. 2.

As shown in FIG. 2, the mobile station generates a random number inside (step ST11), and determines whether a band shift probability reported by the broadcast information is larger than the random number, that is, performs band shift determination (step ST12).

In the band shift determination in step ST12, when the band shift probability is larger than the random number, a home band is updated in step ST13, and shifted to another frequency band (step ST14). In the band shift determination in step ST12, when the band shift probability is not larger than the random number, a home band is updated in step ST15, and the mobile station shifts to a standby state in the band (step ST16). By this means, traffic dispersion of the control channels is performed in the supporting area.

In other words, as shown in FIG. 2, in the band shift determination (step ST12), the mobile station compares the band shift probability reported by the broadcast information with the random number generated inside the mobile station, and determines standby frequency band of its own. The mobile station stores the determined standby frequency band, and subsequently, gives a priority to the frequency band for standby until going out of the supporting area. By this means, traffic dispersion of the control channels is performed in the supporting area.

For such embodiments of the PDC system on 2nd-generation system, also in the W-CDMA (Wideband-Code Division Multiple Access) scheme on 3rd-generation system, it is studied to allocate a new frequency band (band of 800 MHz) other than the existing frequency band (band of 2 GHz).

Accordingly, in the W-CDMA scheme, as in the PDC system, it is expected to introduce the sharing scheme (band sharing scheme) using different frequency bands in the same system.

FIG. 3 shows an example of the mobile communication system to which the conventional band sharing scheme is introduced. As shown in FIG. 3, conventional mobile communication system 10 has a plurality of mobile stations 20, and base station 30 that performs radio communication with the plurality of mobile stations 20. FIG. 3 shows only one mobile station 20 and base station 30.

Mobile station 20 has antenna 21, duplexer 22, adder 23, modulation circuit 24, radio transmitting circuit 25, radio receiving circuit 26, demodulation circuit 27, band control circuit 28 and band measuring circuit 29.

Base station 30 has antenna 31, duplexer 32, adder 33, modulation circuit 34, radio transmitting circuit 35, radio receiving circuit 36, demodulation circuit 37, band determining circuit 38 and band control circuit 39.

Band measuring circuit 29 of mobile station 20 measures reception qualities (reception levels) of different bands. Mobile station 20 transmits the measurement result (band measurement information) to base station 30 together with a transmitting signal. Band determining circuit 38 of base station 30 performs band allocation processing on the band measurement information, and determines a band (band control information). The band control information is transmitted to mobile station 20 together with the transmitting signal.

The band control information is also outputted to band control circuit 39 of base station 30. Then, band control circuits 28 and 39 of mobile station 20 and base station 30 control a radio circuit to be a predetermined band according to the band control information.

Non-patent Document 1: Chiba, et al. “1.5 GHz-band sharing 800 MHz scheme feature, mobile station” NTT DoCoMo Technical Journal Vol. 10 NO. 1

### DISCLOSURE OF INVENTION

### Problems to be Solved by the Invention

However, in the conventional mobile communication system, a band is determined for the purpose of distributing the load simply using a random number without considering radio propagation characteristics in different frequency bands, and therefore there is a problem that the system performance cannot be maximized.

It is therefore an object of the present invention to provide a base station and mobile communication method capable of maximizing the system performance by considering radio propagation characteristics in different frequency bands, maintaining a quality of the signal, and appropriately controlling the transmission power.

### Means for Solving the Problem

A base station of the present invention is a base station that performs radio communication with a plurality of mobile stations, and adopts a configuration having: a mobile speed detecting section that detects a mobile speed of the mobile station; and a band control section that uses a low frequency band when the mobile speed is larger than a predetermined threshold, and uses a high frequency band when the mobile speed is not larger than the predetermined threshold.

A base station of the present invention is a base station in a mobile communication system having a plurality of mobile stations and the base station that performs radio communication with the plurality of mobile stations, and adopts a configuration having: a mobile speed detecting section that detects a mobile speed of the mobile station; and a band control section that changes a frequency band to be used according to the mobile speed.

A mobile communication method of the present invention is a mobile communication method in a mobile communication system having a plurality of mobile stations and a base station that performs radio communication with the plurality of mobile stations, and has: a mobile speed detecting step of detecting, in the base station, a mobile speed of the mobile station; and a band controlling step of using a low frequency band when the detected mobile speed is larger than a predetermined threshold, and using a high frequency band when the mobile speed is not larger than the predetermined threshold.

A base station of the present invention is a base station in a mobile communication system having a plurality of mobile stations and the base station that performs radio communication with the plurality of mobile stations, and adopts a configuration having: a traffic type detecting section that detects whether a traffic type is RT (Real Time) traffic or NRT (Non Real Time) traffic; and a band control section that uses a low frequency band when the traffic type is RT traffic, and uses a high frequency band when the traffic type is NRT traffic.

A base station of the present invention is a base station in a mobile communication system having a plurality of mobile stations and the base station that performs radio communication with the plurality of mobile stations, and adopts a configuration having: a traffic type detecting section that detects a traffic type; and a band control section that changes a frequency band to be used according to the traffic type.

A mobile communication method of the present invention is a mobile communication method in a mobile communication system having a plurality of mobile stations and a base station that performs radio communication with the plurality of mobile stations, and has: a traffic type detecting step of detecting, in the base station, whether a traffic type is RT (Real Time) traffic or NRT (Non Real Time) traffic; and a band controlling step of using a low frequency band when the traffic type is RT traffic, and using a high frequency band when the traffic type is NRT traffic.

### ADVANTAGEOUS EFFECT OF THE INVENTION

According to the present invention, a frequency band to be used is determined based on the mobile speed of the mobile station, detected traffic type, or position of the mobile station, so that it is possible to maximize the system performance by considering radio propagation characteristics in different frequency bands, maintaining quality of the signal, and appropriately controlling the transmission power.

### BRIEF DESCRIPTION OF DRAWINGS

FIG. 1 illustrates a conventional mobile communication system;

FIG. 2 illustrates processing in the conventional mobile communication system;

FIG. 3 is a block diagram showing a configuration of the conventional mobile communication system;

FIG. 4 is a block diagram showing a configuration of a mobile communication system according to Embodiment 1 of the present invention;

FIG. 5 shows the relationship between the speed and fading frequency of a mobile station in the mobile communication system according to Embodiment 1 of the present invention;

FIG. 6 illustrates the path loss with respect to the distance;

FIG. 7 illustrates the fading frequency with respect to the mobile speed of the mobile station;

FIG. 8 is a block diagram showing a configuration of a mobile communication system according to Embodiment 2 of the present invention;

FIG. 9 is a block diagram showing a configuration of a mobile communication system according to Embodiment 3 of the present invention; and

FIG. 10 is a block diagram showing a configuration of a mobile communication system according to Embodiment 4 of the present invention.

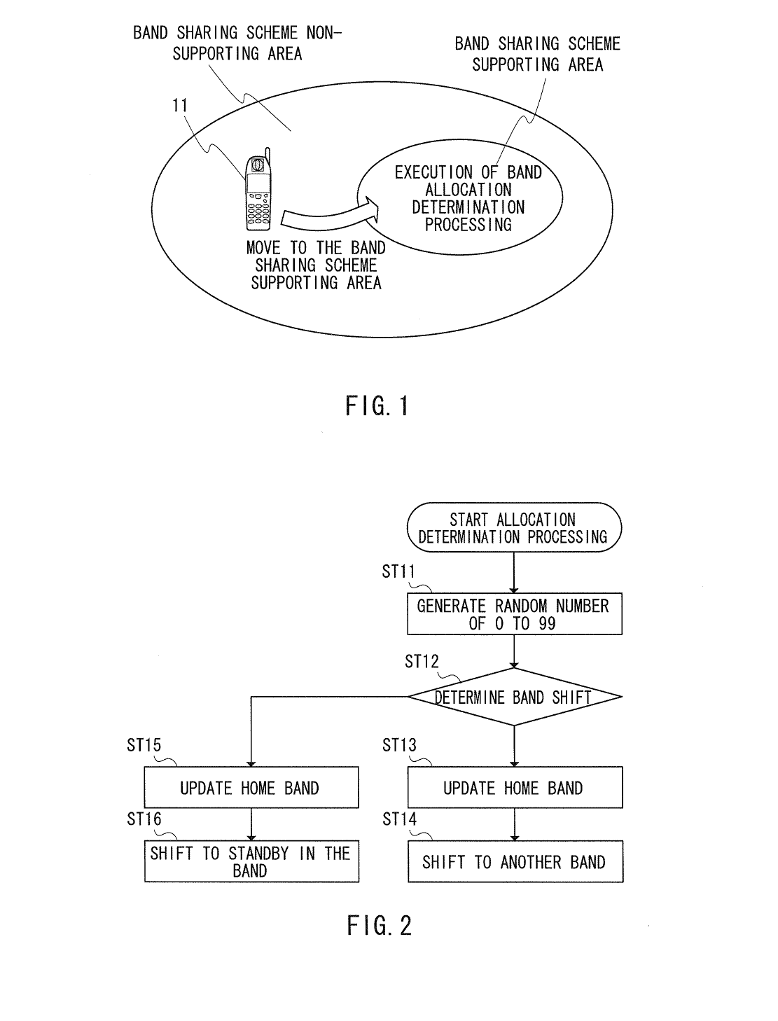

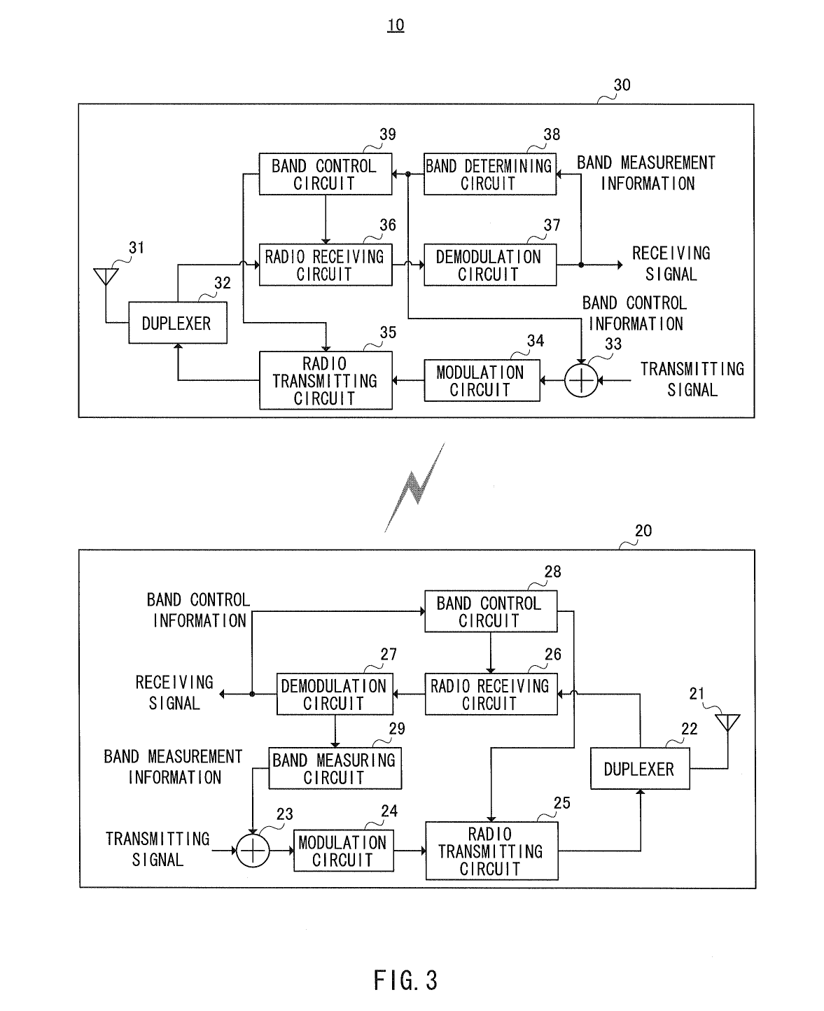

### BEST MODE FOR CARRYING OUT THE INVENTION

Embodiments of the present invention will be described in detail below with reference to the accompanying drawings.

### Embodiment 1

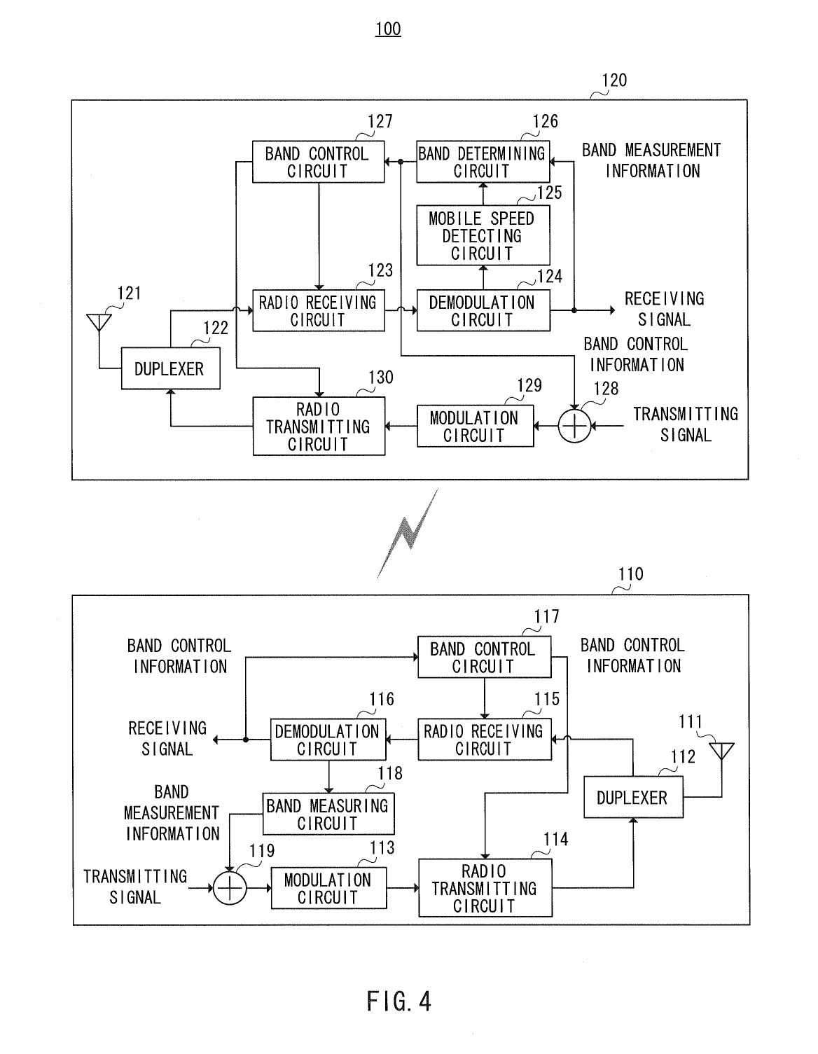

FIG. 4 is a block diagram showing a configuration of the mobile communication system according to Embodiment 1 of the present invention.

As shown in FIG. 4, mobile communication system 100 according to Embodiment 1 of the present invention is provided with a plurality of mobile stations 110 and base station 120 that performs radio communication with the plurality of mobile stations 110. FIG. 4 shows only one mobile station 110.

Mobile station 110 is provided with antenna 111, duplexer 112, modulation circuit 113, radio transmitting circuit 114, radio receiving circuit 115, demodulation circuit 116, band control circuit 117, band measuring circuit 118 and adder 119.

Modulation circuit 113 receives an addition transmitting signal from adder 119 to modulate, and generates a modulated transmitting signal to output to radio transmitting circuit 114. Radio transmitting circuit 114 performs radio transmission processing (processing such as up-conversion) on the modulated transmitting signal from modulation circuit 113, and transmits the result to base station 120 as radio transmitting data via duplexer 112 and antenna 111.

Antenna 111 receives radio transmitting data transmitted from base station 120 to output to radio receiving circuit 115 via duplexer 112. Radio receiving circuit 115 performs radio reception processing (processing such as down-conversion) on the receiving data from antenna 111 via duplexer 112 to output to demodulation circuit 116. Demodulation circuit 116 demodulates the receiving data from radio receiving circuit 115 to generate a receiving signal.

Band control circuit 117 acquires band control information from the receiving signal from demodulation circuit 116 to output to radio transmitting circuit 114 and radio receiving circuit 115. Radio transmitting circuit 114 and radio receiving circuit 115 change the frequency band to be used based on the band control signal from band control circuit 117.

Upon reception of the receiving signal from demodulation circuit 116, band measuring circuit 118 measures reception qualities (reception levels) of different bands to generate band measurement information. The band measurement information is transmitted to base station 120 together with the transmitting signal. In other words, adder 119 adds a value of the band measurement information from band measuring circuit 118 and a value of the transmitting signal to generate an addition transmitting signal, and outputs the result to modulation circuit 113.

Base station 120 is provided with antenna 121, duplexer 122, radio receiving circuit 123, demodulation circuit 124, mobile speed detecting circuit 125, band determining circuit 126, band control circuit 127, adder 128, modulation circuit 129 and radio transmitting circuit 130.

Antenna 121 receives the radio transmitting data transmitted from mobile station 110 to output to radio receiving circuit 123 via duplexer 122. Radio receiving circuit 123 performs radio processing (processing such as down-conversion) on the receiving data from antenna 121 and duplexer 122 to output to demodulation circuit 124. Demodulation circuit 124 demodulates the receiving data from radio receiving circuit 123 to generate a receiving signal.

Mobile speed detecting circuit 125 detects a mobile speed of mobile station 110 in the receiving signal from demodulation circuit 124 to output to band determining circuit 126. Band determining circuit 126 determines a band to be used based on the detected mobile speed from mobile speed detecting circuit 125 and the band measurement information of the receiving signal from demodulation circuit 124, and outputs a band determination result to band control circuit 127.

Band determining circuit 126 determines whether or not the mobile speed is larger than a predetermined threshold, generates a band determination result to instruct, for example, to use a low frequency band when the mobile speed is larger than the predetermined threshold, or to use a high frequency band when the mobile speed is not larger than the predetermined threshold, and outputs the band determination result to band control circuit 127.

In addition, band determining circuit 126 is capable of determining whether or not the mobile speed is smaller than a predetermined threshold, generating a band determination result to instruct, for example, to use a low frequency band when the mobile speed is not smaller than the predetermined threshold, or to use a high frequency band when the mobile speed is smaller than the predetermined threshold, and outputting the band determination result to band control circuit 127.

Based on the band determination result from band determining circuit 126, band control circuit 127 generates a first band control signal or a second band control signal to output to radio receiving circuit 123 and radio transmitting circuit 130.

When receiving the band determination result to instruct to use the low frequency band, band control circuit 127 generates the first band control signal to output to radio receiving circuit 123 and radio transmitting circuit 130. When receiving the first band control circuit, radio receiving circuit 123 and radio transmitting circuit 130 perform the predetermined processing in the low frequency band.

Meanwhile, when receiving the band determination result to instruct to use the high frequency band, band control circuit 127 generates the second band control signal to output to radio receiving circuit 123 and radio transmitting circuit 130. When receiving the second band control circuit, radio receiving circuit 123 and radio transmitting circuit 130 perform the predetermined processing in the high frequency band.

Adder 128 adds a value of the transmitting signal and a value of the band determination result (band control information) from band determining circuit 126, and generates an addition transmitting signal to output to modulation circuit 129. Modulation circuit 129 modulates the addition transmitting signal from adder 128 to output to radio transmitting circuit 130. Radio transmitting circuit 130 performs the radio transmission processing (processing such as up-conversion) on the modulated transmitting signal to transmit to mobile station 110 as radio transmitting data via duplexer 122 and antenna 121.

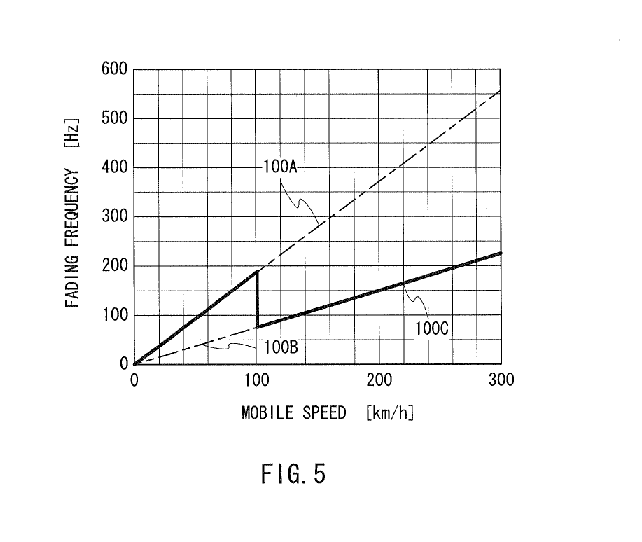

Next, a specific example of the operation of band determining circuit 126 and band control circuit 127 will be described with reference to FIG. 5.

FIG. 5 shows the relationship between the speed and fading frequency of a mobile station. Characteristic 100A in FIG. 5 is a characteristic line showing the relationship between the speed and fading frequency of the mobile station when the mobile station uses a band of 2 GHz. Characteristic 100B in FIG. 5 is a characteristic line showing the relationship between the speed and fading frequency of the mobile station when the mobile station uses a band of 800 MHz.

For example, band determining circuit 126 determines whether or not the detected mobile speed is larger than 100 km/h, generates a band determination result to instruct to use a low frequency band of 800 MHz when the detected mobile speed is larger than 100 km/h, generates a band determination result to instruct to use a high frequency band of 2 GHz when the detected mobile speed is not larger than 100 km/h, and outputs the band determination result to band control circuit 127.

In addition, for example, band determining circuit 126 is capable of determining whether or not the detected mobile speed is smaller than 100 km/h, generating a band determination result to instruct to use the low frequency band of 800 MHz when the detected mobile speed is not smaller than 100 km/h, generating a band determination result to instruct to use the high frequency band of 2 GHz when the detected mobile speed is smaller than 100 km/h, and outputting the band determination result to band control circuit 127.

Upon reception of the band determination result to instruct to use the low frequency band, band control circuit 127 generates the first band control signal to output to radio receiving circuit 123 and radio transmitting circuit 130. When receiving the first band control circuit, radio receiving circuit 123 and radio transmitting circuit 130 perform the predetermined processing in the low frequency band of 800 MHz.

Meanwhile, when receiving the band determination result to instruct to use the high frequency band, band control circuit 127 generates the second band control signal to output to radio receiving circuit 123 and radio transmitting circuit 130. When receiving the second band control circuit, radio receiving circuit 123 and radio transmitting circuit 130 perform the predetermined processing in the high frequency band of 2 GHz. In this case, that is, in Embodiment 1 of the present invention, characteristic curve C showing the relationship between the speed and fading frequency of the mobile station is shown by solid line in FIG. 5.

Next, in Embodiment 1 of the present invention, use of the low frequency band when the detected mobile speed of mobile station 110 is larger than a predetermined threshold, and use of the high frequency band when the detected mobile speed is not larger than the predetermined threshold will be described in detail. In addition, it is the same if the low frequency band is used when the detected mobile speed of mobile station 110 is not smaller than a predetermined threshold, and the high frequency band is used when the detected mobile speed is smaller than the predetermined threshold.

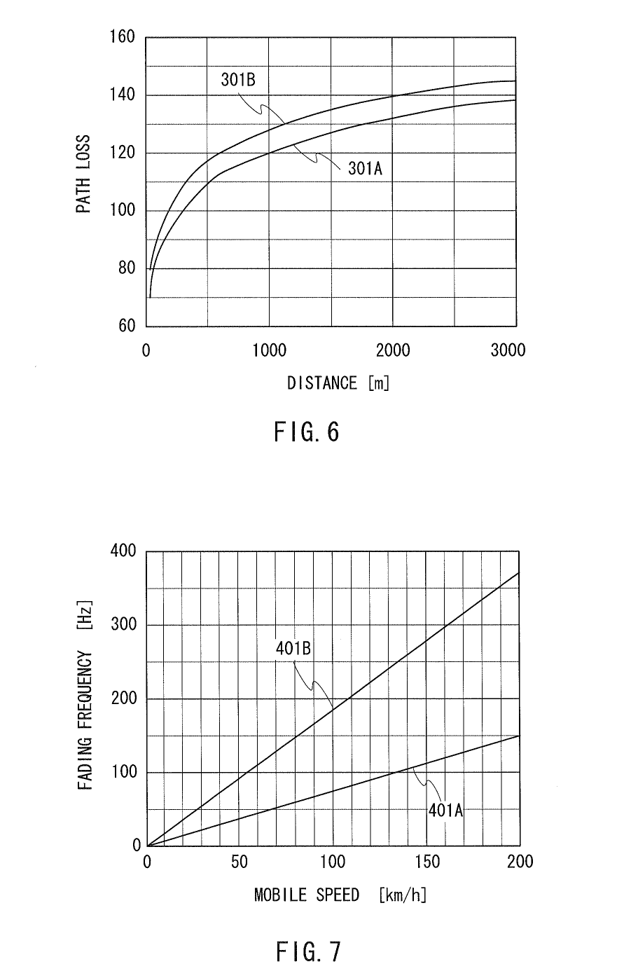

First, considering the path loss with respect to the distance in the frequency bands of 800 MHz and 2 GHz, as shown in FIG. 6, in the case of cellular environments, the path loss in the frequency band of 800 MHz (characteristic curve 301A in FIG. 6) is smaller than the path loss in the frequency band of 2 GHz (characteristic curve 301B in FIG. 6). Accordingly, it is understood that radio propagation characteristics are good in the low frequency band.

Further, considering the fading frequency with respect to the mobile speed of mobile station 110, as shown in FIG. 7, in the same mobile speed, the fading frequency in the frequency band of 800 MHz (characteristic 401A in FIG. 7) is smaller than the fading frequency in the frequency band of 2 GHz (characteristic 401B in FIG. 7). Accordingly, it is understood that the fading fluctuation is small in the low frequency band. It is further understood that a difference in the fading frequency becomes larger between different frequency bands in accordance with an increase of the mobile speed. When the difference between different frequency bands further increases, the above-mentioned phenomenon becomes remarkable.

Thus, in the low frequency band, the radio propagation characteristics are good, and the fading fluctuation is small. Therefore, it is defined in Embodiment 1 of the present invention that the low frequency band is used when the detected mobile speed of mobile station 110 is larger than the predetermined threshold, and the high frequency band is used when the detected mobile speed is not larger than the predetermined threshold.

In addition, in Embodiment 1 of the present invention, band control circuit 127 may be configured to change the frequency band to be used in three or more stages according to the mobile speed of mobile station 110.

### Embodiment 2

Embodiment 2 of the present invention will be described in detail below with reference to the drawing.

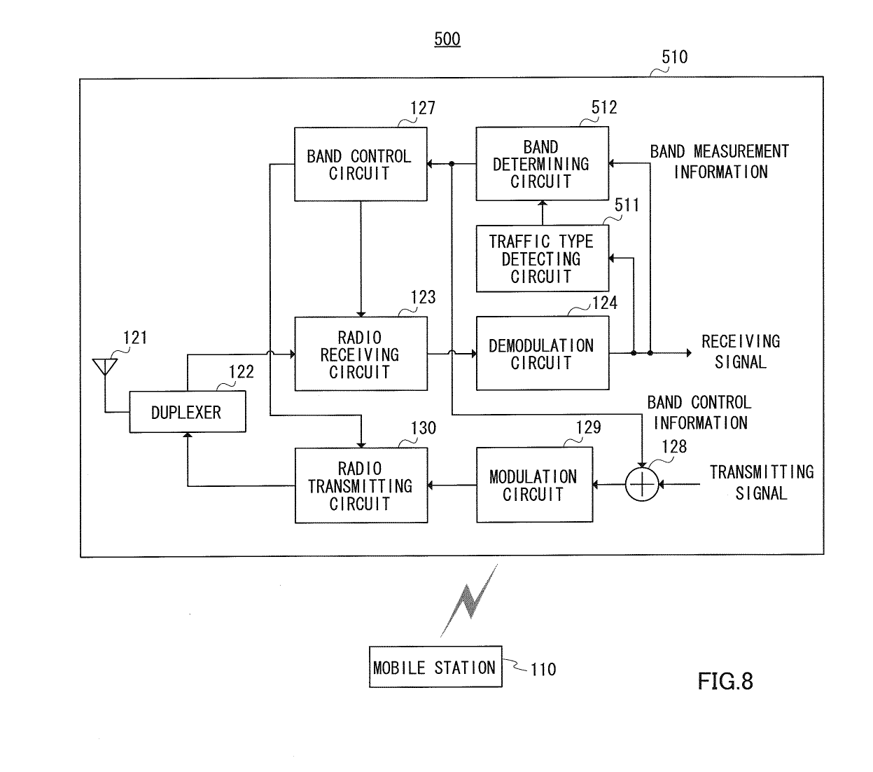

FIG. 8 is a block diagram showing a configuration of a mobile communication system according to Embodiment 2 of the present invention. In Embodiment 2 of the present invention, components that are the same as in Embodiment 1 of the present invention will be assigned the same reference numerals without further explanations.

As shown in FIG. 8, mobile communication system 500 according to Embodiment 2 of the present invention is provided with a plurality of mobile stations 110 and base station 510 that performs radio communication with the plurality of mobile stations 110. FIG. 8 shows only one mobile station 110 and base station 510.

Base station 510 immobile communication system 500 according to Embodiment 2 of the present invention has traffic type detecting circuit 511 and band determining circuit 512 respectively in place of mobile speed detecting circuit 125 and band determining circuit 126 in base station 120 of mobile communication system 100 according to Embodiment 1 of the present invention.

Next, the operation of mobile communication system 500 according to Embodiment 2 of the present invention which is different from that of mobile communication system 100 according to Embodiment 1 of the present invention will be described with reference to the drawing.

Upon reception of a receiving signal from demodulation circuit 124, traffic type detecting circuit 511 detects whether a traffic type is RT (Real Time) traffic or NRT (Non Real Time) traffic, and generates a detection traffic type to output to band determining circuit 152.

Band determining circuit 512 generates a band determination result to instruct to use a low frequency band when the detection traffic type is RT traffic, and generates a band determination result to instruct to use a high frequency band when the detection traffic type is NRT traffic, and outputs the band determination result to band control circuit 127.

Based on the band determination result from band determining circuit 512, band control circuit 127 generates a first band control signal or a second band control signal to output to radio receiving circuit 123 and radio transmitting circuit 130.

When receiving the band determination result to instruct to use the low frequency band, band control circuit 127 outputs the first band control signal to radio receiving circuit 123 and radio transmitting circuit 130. When receiving the first band control circuit, radio receiving circuit 123 and radio transmitting circuit 130 perform the predetermined processing in the low frequency band.

Meanwhile, when receiving the band determination result to instruct to use the high frequency band, band control circuit 127 outputs the second band control signal to radio receiving circuit 123 and radio transmitting circuit 130. When receiving the second band control circuit, radio receiving circuit 123 and radio transmitting circuit 130 perform the predetermined processing in the high frequency band.

This is because of the following reason. QoS (Quality Of Service) is moderate in NRT traffic, but strict in RT traffic. In other words, NRT traffic has a low target quality, and permits delay of arrival time of a packet to be received in mobile station 110. On the other hand, RT traffic has a high target quality, and does not permit delay of packet arrival time. Therefore, by using the low frequency band with good radio propagation characteristics in the case of RT traffic, QoS is satisfied, and adequate power resources are maintained. Further, throughput is improved in the low frequency band compared to the high frequency band, so that it is possible to perform efficient transmission.

In addition, types of traffic include various types such as Web Browsing, FTP and Streaming. Accordingly, in Embodiment 2 of the present invention, it is also possible to adopt a configuration of changing the frequency band to be used in three or more stages according to the traffic type.

### Embodiment 3

Embodiment 3 of the present invention will be described in detail below with reference to the drawing.

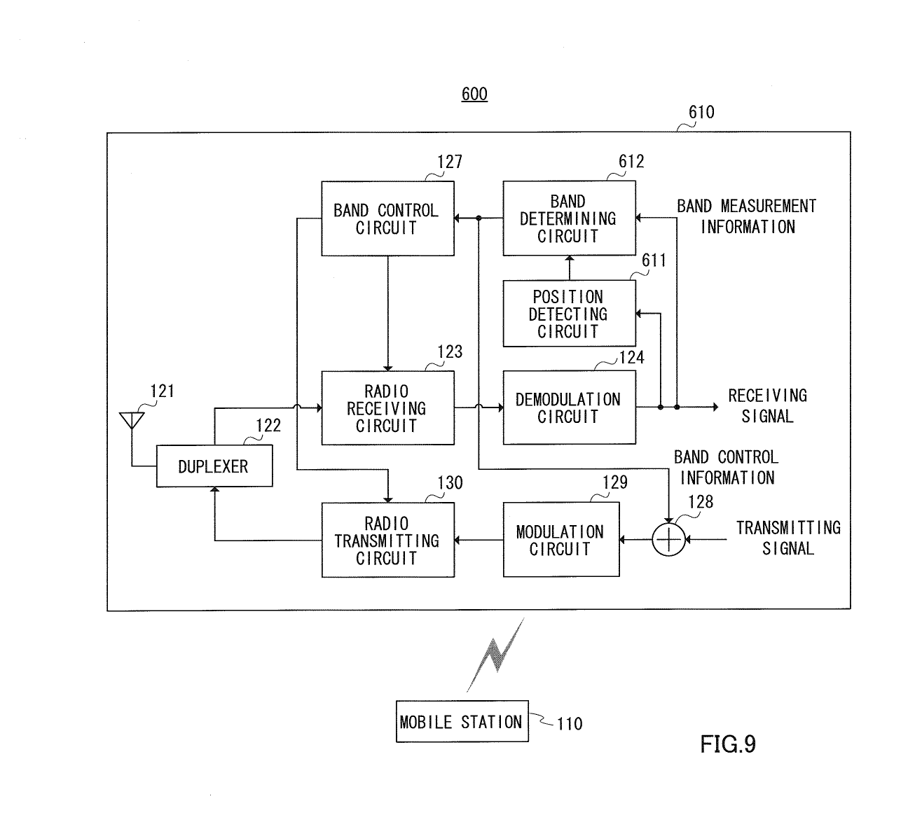

FIG. 9 is a block diagram showing a configuration of a mobile communication system according to Embodiment 3 of the present invention. In Embodiment 3 of the present invention, components that are the same as in Embodiment 1 of the present invention will be assigned the same reference numerals without further explanations.

As shown in FIG. 9, mobile communication system 600 according to Embodiment 3 of the present invention is provided with a plurality of mobile stations 110 and base station 610 that performs radio communication with the plurality of mobile stations 110. FIG. 9 shows only one mobile station 110 and base station 610.

Base station 610 immobile communication system 600 according to Embodiment 3 of the present invention has position detecting circuit 611 and band determining circuit 612 respectively in place of mobile speed detecting circuit 125 and band determining circuit 126 in base station 120 of mobile communication system 100 according to Embodiment 1 of the present invention.

Next, the operation of mobile communication system 600 according to Embodiment 3 of the present invention which is different from that of mobile communication system 100 according to Embodiment 1 of the present invention will be described with reference to the drawing.

Position detecting circuit 611 detects a position of mobile station 110, and outputs position information to band determining circuit 612.

Band determining circuit 612 generates a band determination result to instruct to use a low frequency band when the position information indicates that mobile station 110 is positioned in an end portion of the cell of base station 610 or in a position away from the base station, and generates a band determination result to use a high frequency band when the position information indicates that mobile station 110 is in a position other than the end portion of the cell, or in a position near the base station, and outputs the band determination result to band control circuit 127.

Based on the band determination result from band determining circuit 612, band control circuit 127 generates a first band control signal or a second band control signal to output to radio receiving circuit 123 and radio transmitting circuit 130.

When receiving the band determination result to instruct to use the low frequency band, band control circuit 127 outputs the first band control signal to radio receiving circuit 123 and radio transmitting circuit 130. When receiving the first band control circuit, radio receiving circuit 123 and radio transmitting circuit 130 perform the predetermined processing in the low frequency band.

Meanwhile, when receiving the band determination result to instruct to use the high frequency band, band control circuit 127 outputs the second band control signal to radio receiving circuit 123 and radio transmitting circuit 130. When receiving the second band control circuit, radio receiving circuit 123 and radio transmitting circuit 130 perform the predetermined processing in the high frequency band.

This is because of the following reason. When mobile station 110 is positioned in the end portion of the cell far from base station 610, adequate power resources are required due to quality deterioration by distance attenuation of the signal level caused by the long distance between base station 610 and mobile station 110 and interference from other cells. Therefore, when mobile station 110 is positioned in the end portion of the cell far from base station 610, by using the low frequency band with good radio propagation characteristics, it is possible to reduce the distance attenuation and reduce the transmission power.

In addition, in Embodiment 3 of the present invention, it is also possible to adopt a configuration of changing the frequency band to be used in three or more stages according to the position information.

Further, in Embodiment 3, the frequency band to be used may be changed according to whether mobile station 110 is positioned inside or outside a building or the like. For example, it is also possible to adopt a configuration where mobile station 110 and base station 610 use the low frequency band when mobile station 110 is positioned in an indoor area, and use the high frequency band when mobile station 110 is positioned in an outdoor area.

In this case, base station 610 is provided with: an indoor/outdoor position detecting circuit that detects whether mobile station 110 is positioned in an indoor area or outdoor area to generate indoor/outdoor position information; and a band control circuit that uses the low frequency band when mobile station 110 is positioned in an indoor area, and uses the high frequency band when mobile station 110 is positioned in an outdoor area.

For example, in the case of mobile station 110 having GPS therein, the indoor/outdoor position detecting circuit may use any method such as a method of determining that mobile station 110 is positioned in an indoor area when mobile station 110 cannot receive a radio signal of the satellite, and determining that mobile station 110 is positioned in an outdoor area when mobile station 110 can receive a radio signal of the satellite, if the method is aimed at detection for determining whether the mobile station is positioned in an indoor area or outdoor area.

This is because the radio signal loss is large due to walls and the like when mobile station 110 is positioned in an indoor area, and the radio signal loss is small when mobile station 110 is positioned in an outdoor area as compared to the indoor area.

### Embodiment 4

Embodiment 4 of the present invention will be described in detail below with reference to the drawing.

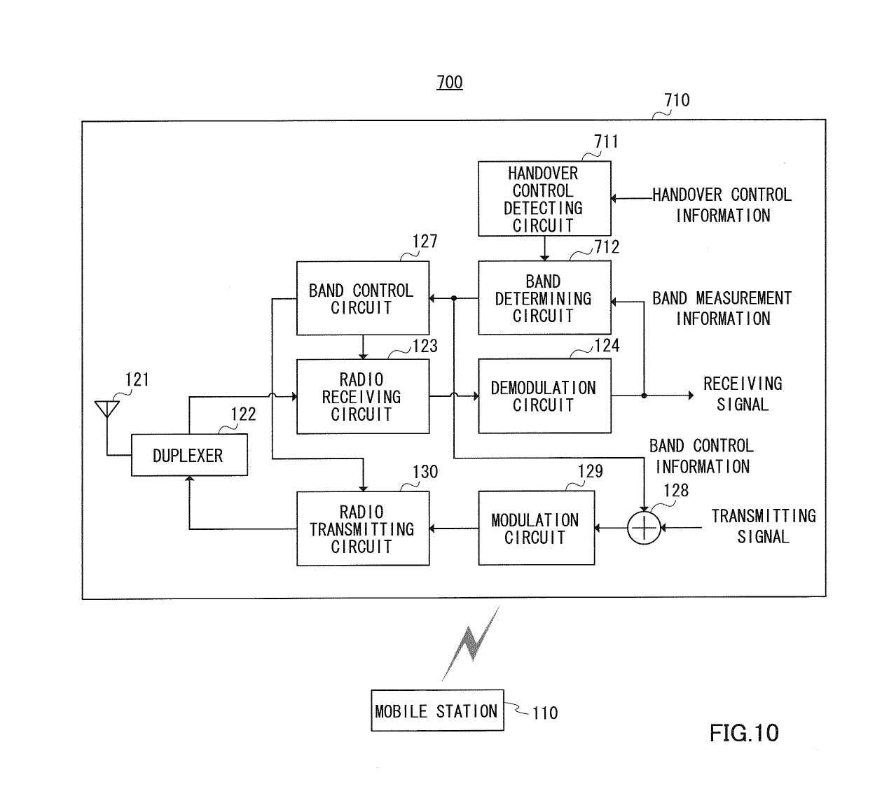

FIG. 10 is a block diagram showing a configuration of a mobile communication system according to Embodiment 4 of the present invention. In Embodiment 4 of the present invention, components that are the same as in Embodiment 1 of the present invention will be assigned the same reference numerals without further explanations.

As shown in FIG. 10, mobile communication system 700 according to Embodiment 4 of the present invention is provided with a plurality of mobile stations 110 and base station 710 that performs radio communication with the plurality of mobile stations 110. FIG. 10 shows only one mobile station 110 and base station 710.

Base station 710 immobile communication system 700 according to Embodiment 4 of the present invention has handover control detecting circuit 711 and band determining circuit 712 respectively in place of mobile speed detecting circuit 125 and band determining circuit 126 in base station 120 of mobile communication system 100 according to Embodiment 1 of the present invention.

Next, the operation of mobile communication system 700 according to Embodiment 4 of the present invention which is different from that of mobile communication system 100 according to Embodiment 1 of the present invention will be described with reference to the drawing.

Upon reception of the handover control information, handover control detecting circuit 711 detects that mobile station 110 is positioned in an area of handover control of the cell of base station 710, and outputs handover control area information to band determining circuit 712.

Band determining circuit 712 generates a band determination result to instruct to use a low frequency band when the handover control area information indicates that mobile station 110 is positioned in an area of handover control of the cell of base station 7, and generates a band determination result to instruct to use a high frequency band when the handover control area information indicates that mobile station 110 is positioned in an area other than the area of handover control of the cell of base station 710, and outputs the band determination result to band control circuit 127.

Based on the band determination result from band determining circuit 712, band control circuit 127 generates a first band control signal or a second band control signal to output to radio receiving circuit 123 and radio transmitting circuit 130.

When receiving the band determination result to instruct to use the low frequency band, band control circuit 127 outputs the first band control signal to radio receiving circuit 123 and radio transmitting circuit 130. When receiving the first band control circuit, radio receiving circuit 123 and radio transmitting circuit 130 perform the predetermined processing in the low frequency band.

Meanwhile, when receiving the band determination result to instruct to use the high frequency band, band control circuit 127 outputs the second band control signal to radio receiving circuit 123 and radio transmitting circuit 130. When receiving the second band control circuit, radio receiving circuit 123 and radio transmitting circuit 130 perform the predetermined processing in the high frequency band.

This is because of the following reason. When mobile station 110 is positioned in an area of handover control of the cell of base station 710, since mobile station 110 is usually positioned near the end portion of the cell, adequate power resources are required due to quality deterioration by attenuation of the signal caused by the long distance between base station 710 and mobile station 110 and interference from other cells. Therefore, when mobile station 110 is positioned in the area of handover control of the cell of base station 710, by using the low frequency band with good radio propagation characteristics, it is possible to reduce the distance attenuation and reduce the transmission power.

In addition, the present invention includes embodiments of a combination of at least two or more of Embodiments 1 to 4.

The present application is based on Japanese Patent Application No. 2004-274137, filed on Sep. 21, 2004, entire content of which is expressly incorporated by reference herein.

### INDUSTRIAL APPLICABILITY

The present invention provides an advantage of maximizing the system performance by considering radio propagation characteristics in some different frequency bands, maintaining a quality of the signal, and appropriately controlling the transmission power, and is suitable for use in a base station in a mobile communication system.

1. A base station in a mobile communication system comprising a plurality of mobile stations and the base station that performs radio communication with the plurality of mobile stations, the base station comprising:
a mobile speed detecting section that detects a mobile speed of the mobile station; and
a band control section that uses a low frequency band when the mobile speed is larger than a predetermined threshold, and uses a high frequency band when the mobile speed is not larger than the predetermined threshold.

2. A base station in a mobile communication system comprising a plurality of mobile stations and the base station that performs radio communication with the plurality of mobile stations, the base station comprising:
a mobile speed detecting section that detects a mobile speed of the mobile station; and
a band control section that changes a frequency band to be used according to the mobile speed.

3. A mobile communication method in a mobile communication system comprising a plurality of mobile stations and a base station that performs radio communication with the plurality of mobile stations, the mobile communication method comprising:
a mobile speed detecting step of detecting, in the base station, a mobile speed of the mobile station; and
a band controlling step of using a low frequency band when the detected mobile speed is larger than a predetermined threshold, and using a high frequency band when the mobile speed is not larger than the predetermined threshold.

4. A base station in a mobile communication system comprising a plurality of mobile stations and the base station that performs radio communication with the plurality of mobile stations, the base station comprising:
a traffic type detecting section that detects whether a traffic type is RT (Real Time) traffic or NRT (Non Real Time) traffic; and
a band control section that uses a low frequency band when the traffic type is RT traffic, and uses a high frequency band when the traffic type is NRT traffic.

5. A base station in a mobile communication system comprising a plurality of mobile stations and the base station that performs radio communication with the plurality of mobile stations, comprising:
a traffic type detecting section that detects a traffic type; and
a band control section that changes a frequency band to be used according to the traffic type.

6. A mobile communication method in a mobile communication system comprising a plurality of mobile stations and a base station that performs radio communication with the plurality of mobile stations, the mobile communication method comprising:
a traffic type detecting step of detecting, in the base station, whether a traffic type is RT (Real Time) traffic or NRT (Non Real Time) traffic; and
a band controlling step of using a low frequency band when the traffic type is RT traffic, and using a high frequency band when the traffic type is NRT traffic.
